(19) United States
(12) Patent Application Publication
(10) Pub. No.: US 2018/0257184 A1
(43) Pub. Date: Sep. 13, 2018

(54) IMPELLER SHELL WITH THICKENED JUNCTION AND METHOD THEREOF

(71) Applicant: Schaeffler Technologies AG & Co. KG, Herzogenaurach (DE)

(72) Inventors: David Brucato, Ashland, OH (US); Charles Nichols, Seville, OH (US)

(73) Assignee: Schaeffler Technologies AG & Co. KG, Herzogenaurach (DE)

(21) Appl. No.: 15/534,331

(22) PCT Filed: Jan. 23, 2015
(86) PCT No.: PCT/US2015/012678

§ 371 Date: Jun. 8, 2017

(51) Int. Cl. B23P 15/00; F16H 41/28

(52) U.S. Cl. CPC B23P 15/006; F16H 45/02; F16H 41/28

(57) ABSTRACT

A torque converter, including an impeller including an impeller shell with an inner surface, an outer surface facing opposite the inner surface, a first radial portion substantially orthogonal to an axis of rotation for the torque converter, and an axial portion substantially parallel to the axis, extending from the radial portion, forming a radially outmost portion of the impeller shell, and having a first thickness. The shell includes a curved portion including a first protrusion, second and third protrusions radially inward of the first protrusion, a first portion between the radial portion and the first protrusion, and a junction portion connecting the radial portion and the first portion and having a second thickness at least 50 percent greater than the first thickness.

### CROSS-REFERENCE TO RELATED APPLICATIONS

The present application is the U.S. national stage application pursuant to 35 U.S.C. § 371 of International Application No. PCT/US2015/012678, filed Jan. 23, 2015, which application is incorporated herein by reference in its entirety.

### FIELD

The present disclosure relates generally to an impeller shell having a thickened junction between a curved portion to which impeller blades are attached and a portion extending radially outward from the curved portion. The present disclosure also relates to a method of fabricating the impeller described above.

### BACKGROUND

FIG. 9 is a cross-sectional view of a portion of a prior art impeller shell. Impeller shell 300 includes curved portion 302 and radial portion 304 substantially orthogonal to axis of rotation AR for the shell. Protrusion 306 is formed as a result of stamping portion 302 to form slots 308 for receiving a tab (not shown) for an impeller blade to be fixed to shell 300. For a shell 300 fabricated from a sheet of metal, for example by stamping and coining operations, shell 300 has nominal thickness T1 except at protrusions such as 306. Junction 308 is subject to extreme stress during operation of a torque converter including shell 300. However, thickness T2 of shell 300 at junction 308 is only nominally more than T1, which leads an undesirable decrease in the robustness and service life of shell 300 and a torque converter including shell 300.

FIGS. 10A and 10B are cross-sectional views of a prior art process for fabricating impeller shell 300 from a sheet of metal. The sheet is placed in space 310 between dies 312, 314, 316, and 318 and compressed between the dies to attain the shape shown in FIG. 9. Die 312 includes indentation 320 arranged to receive protrusions 306 without flattening the protrusions during formation of shell 300. Die 312 includes indentations 322 arranged to receive protrusions on shell 300 without flattening the protrusions during formation of shell 300. Die 318 includes indentation 324 arrange to receive protrusion on shell 300 without flattening the protrusion during formation of shell 300.

FIG. 11 is a cross-sectional view along line 11-11 in FIG. 10B. Each of indentations 320 (shown in FIG. 10), 322 and 324 is in the form of a respective continuous groove to enable dies 312 and 318 to be engage with and disengage from protrusions 306 and protrusions on shell 300 aligned with 308 and 310. That is, the curved shape of dies 312 and 318 must be able to displace in directions D1 and D2, without snagging on the protrusions.

Compressive force applied by dies 312 and 316 to a portion of the sheet of metal in space 310A causes material in that portion to flow toward space 3102B, in which junction 308 would be located. However, the compressive force between dies 312 and 314 is not sufficient to prevent most of the flowing material to continue past space 310B and into space 310C. Thus, junction 308 is only nominally thickened. Specifically, the dashed lines in FIG. 11 represent the sheet of metal with protrusions 306. Spaces 326 are left between respective protrusions 306. Die 318 does not flatten protrusions 306 (distance 328 is substantially the same before and after compression by dies 312 and 314); therefore, there is little or no compressive force being applied to the sheet at areas corresponding to the spaces in the grooves, enabling the flow of material past junction 308 and into portion 302.

### SUMMARY

According to aspects illustrated herein, there is provided a torque converter, including a cover arranged to receive torque, a turbine including a turbine shell and a turbine blade fixedly connected to the turbine shell, and an impeller including an impeller shell non-rotatably connected to the cover and including, an inner surface facing the turbine, an outer surface facing opposite the inner surface, a first radial portion substantially orthogonal to an axis of rotation for the torque converter, and an axial portion substantially parallel to the axis of rotation, extending from the radial portion, forming a radially outmost portion of the impeller shell, and having a first thickness. The shell includes a curved portion including a first protrusion, second and third protrusions radially inward of the first protrusion, a first portion between the first and second protrusions, and a junction portion connecting the radial portion and the curved portion and having a second thickness at least 50 percent greater than the first thickness. The torque converter includes an impeller blade fixed to the impeller shell proximate the first, second, and third protrusions.

According to aspects illustrated herein, there is provided a method of fabricating an impeller for a torque converter, including forming, using a first plurality of protrusions on a first die and a plurality of indentations in a second die, first, second, and third protrusions extending from a first side of a sheet of metal, the sheet of metal having a first thickness, forming, using the first pluralities of protrusions and the plurality of indentations, first, second, and third slots in the first, second, and third protrusions, respectively, clamping a first portion of the sheet metal, including the first protrusion and the first slot, between a first smooth and continuous curved shape formed by a first portion of a third die facing the first side and a second smooth and continuous curved shape formed by a first portion of a fourth die, compressing a first end portion of the sheet of metal, continuous with the first portion of the sheet metal, between a first surface formed by a second portion of the third die and a second surface formed by a fifth die, flowing material forming the first end portion into a junction between the first portion and the first end portion, blocking the flow of to material from the junction to the first portion, and increasing the thickness of the sheet of metal at the junction to a second thickness greater than the first thickness by at least 50 percent.

According to aspects illustrated herein, there is provided a method of fabricating an impeller for a torque converter, including forming, using a first plurality of protrusions on a first die and a plurality of indentations in a second die, first, second, and third protrusions extending from a first side of a sheet of metal, the sheet of metal having a first thickness, forming, using the first pluralities of protrusions and the plurality of indentations, first die, first, second, and third slots in the first, second, and third protrusions, respectively, clamping a first portion of the sheet metal, including the first protrusion and the first slot, between a first smooth and continuous curved shape formed by a first portion of a third die facing the first side and a second smooth and continuous curved shape formed by a first portion of a fourth die, at least partially flattening the first protrusion with the first portion of the third die, compressing a first end portion of the sheet of metal, continuous with the first portion of the sheet metal, between a first surface formed by a second portion of the third die and a second surface formed by a fifth die, flowing material forming the first end portion into a junction between the first portion and the first end portion, blocking the flow of material from the junction to the first portion, and increasing the thickness of the sheet of metal at the junction to a second thickness greater than the first thickness by at least 50 percent.

These and other objects, features, and advantages of the present disclosure will become readily apparent upon a review of the following detailed description of the disclosure, in view of the drawings and appended claims.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a perspective view of a cylindrical coordinate system demonstrating spatial terminology used in the present application;

FIG. 2 is a cross-section view of a torque converter including an impeller shell with a thickened junction;

FIG. 3 is a detail of the impeller shell in FIG. 2;

FIGS. 4 through 7B illustrate an example method of fabricating an impeller shell with a thickened junction;

FIGS. 8A and 8B illustrate flattening of a protrusion on the impeller shell of FIG. 3;

FIG. 9 is a cross-sectional view of a portion of a prior art impeller shell;

FIGS. 10A and 10B are cross-sectional views of a prior art process for fabricating an impeller shell from a sheet of metal; and,

FIG. 11 is a cross-sectional view along line 11-11 in FIG. 10.

### DETAILED DESCRIPTION

At the outset, it should be appreciated that like drawing numbers on different drawing views identify identical, or functionally similar, structural elements of the disclosure. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

By “non-rotatably connected” elements, we mean that: the elements are connected so that whenever one of the elements rotate, all the elements rotate; and, relative rotation between the elements is not possible. Radial and/or axial movement of non-rotatably connected elements with respect to each other is possible, but not required.

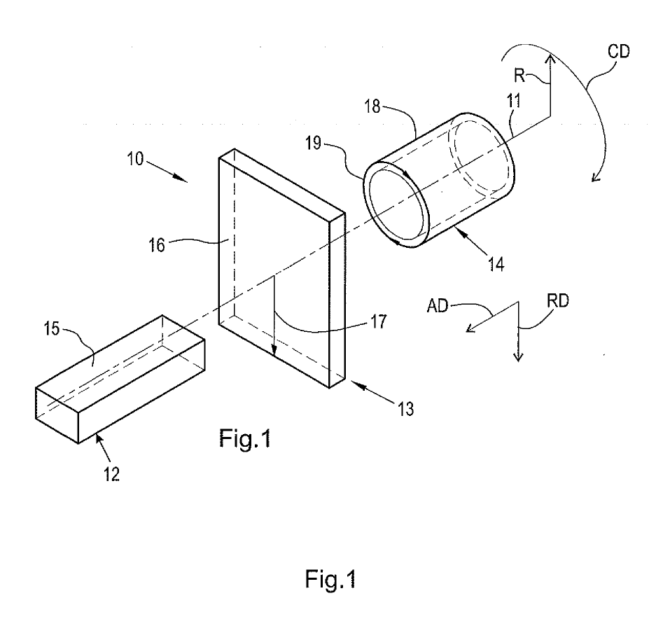

Adverting now to the figures, FIG. 1 is a perspective view of cylindrical coordinate system 10 demonstrating spatial terminology used in the present application. The present application is at least partially described within the context of a cylindrical coordinate system. System 10 includes longitudinal axis 11, used as the reference for the directional and spatial terms that follow. Axial direction AD is parallel to axis 11. Radial direction RD is orthogonal to axis 11. Circumferential direction CD is defined by an endpoint of radius R (orthogonal to axis 11) rotated about axis 11.

To clarify the spatial terminology, objects 12, 13, and 14 are used. An axial surface, such as surface 15 of object 12, is formed by a plane co-planar with axis 11. Axis 11 passes through surface 15; however any surface co-planar with axis 11 is an axial surface. A radial surface, such as surface 16 of object 13, is formed by a plane orthogonal to axis 11 and co-planar with a radius, for example, radius 17. Radius 17 passes through surface 16; however any surface co-planar with radius 17 is a radial surface. Surface 18 of object 14 forms a circumferential, or cylindrical, surface. For example, circumference 19 is passes through surface 18. As a further example, axial movement is parallel to axis 11, radial movement is orthogonal to axis 11, and circumferential movement is parallel to circumference 19. Rotational movement is with respect to axis 11. The adverbs “axially,” “radially,” and “circumferentially” refer to orientations parallel to axis 11, radius 17, and circumference 19, respectively. For example, an axially disposed surface or edge extends in direction AD, a radially disposed surface or edge extends in direction R, and a circumferentially disposed surface or edge extends in direction CD.

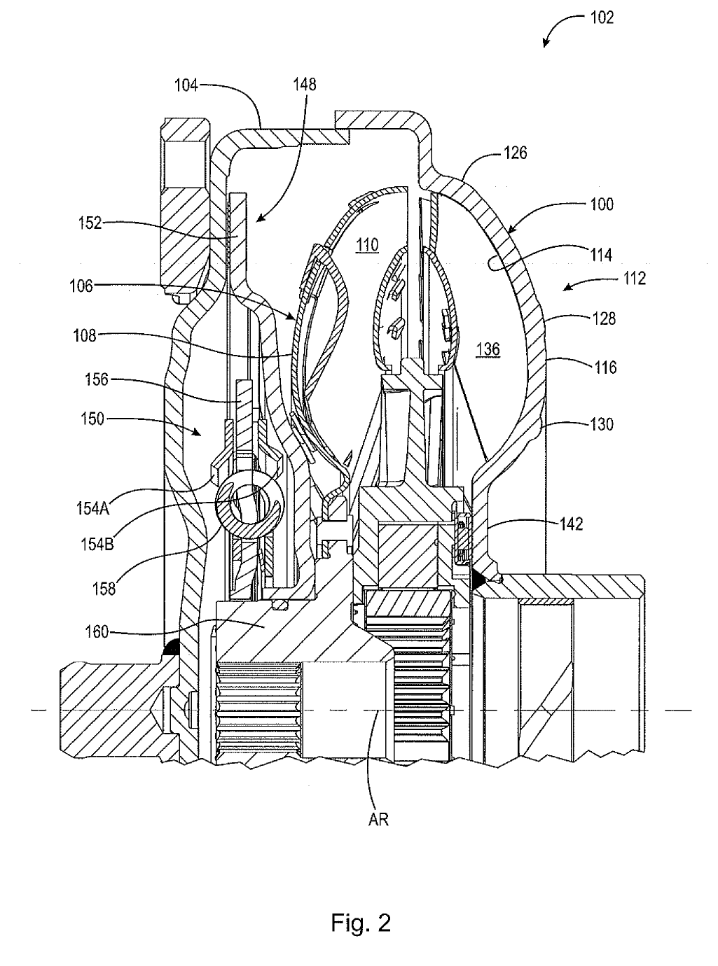

FIG. 2 is a cross-section view of a torque converter including impeller shell 100 with a thickened junction.

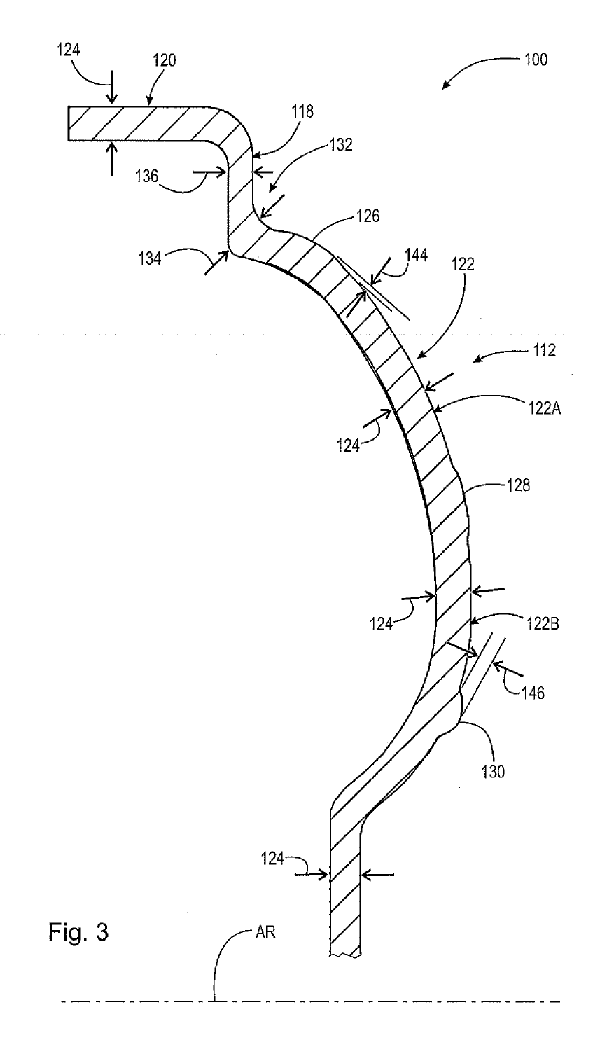

FIG. 3 is a detail of impeller shell 100 in FIG. 2. The following should be viewed in light of FIGS. 2 and 3. In an example embodiment, impeller shell 100 is part of torque converter 102. Torque converter 102 includes: cover 104 arranged to receive torque; turbine 106 including turbine shell 108 at least one turbine blade 110 fixedly connected to the turbine shell; and impeller 112 including impeller shell 100. Shell 100 is non-rotatably connected to cover 104 and includes inner surface 114 facing the turbine, outer surface 116 facing opposite the inner surface, radial portion 118 substantially orthogonal to axis of rotation AR for the torque converter, axial portion 120, and curved portion 122. Portion 120 is substantially parallel to axis of rotation AR, extends from radial portion 118, forms the to radially outmost portion of impeller shell 100, and has thickness 124. In an example embodiment, thickness 124 is the original thickness of a sheet of metal from which shell 100 is fabricated.

Curved portion 122 includes at least one protrusion 126, least one each protrusions 128 and 130 radially inward of least one protrusion 124 (herein after, to simplify presentation least one protrusion 126, least one protrusions 128 and at least one protrusion 130 are referred to as protrusion 126, protrusions 128 and protrusion 130, respectively). Shell 100 includes junction portion 132 connecting radial portion 118 and portion 122 and having thickness 134 at least 50% greater than thickness 124. Impeller 112 includes at least one blade 136 fixed to impeller shell proximate protrusions 126, 128 and 130. For example, tabs (not shown) are inserted in slots (further described below), associated with respective protrusions 126, 128 and 130. Thicknesses 124 and 134 are measured orthogonal to surface 114 or surface 116. In an example embodiment, radial portion 118 has thickness 136 less than thickness 124. As described below, material in portion 118 has been transferred (flowed) from portion 118 to junction portion 132.

Impeller shell 100 includes radial portion 142 radially inward of protrusions 126, 128 and 130, in particular, radially inward of protrusion 130. Portion 142 is substantially orthogonal to axis of rotation AR, forms a radially inmost portion of impeller shell 100 and has thickness 124.

Protrusion 126 extends past portion 122A by distance 144. Portion 122A is between protrusions 126 and 128 and has thickness 124. Portion 122 includes portion 122B between protrusions 128 and 130 and having thickness 124. Protrusion 130 extends past portion 122B by distance 146 greater than distance 144. In an example embodiment, distance 146 is at least twice distance 144. In an example embodiment, protrusion 128 extends past portion 122B by distance 144.

Torque converter 102 includes lock up clutch 148 and damper 150. Lock up clutch 148 includes piston 152 axially displaceable to non-rotatably engage the cover to close clutch 148. Damper 150 includes input cover plates 154A and 154B non-rotatably connected to each other and piston 152, output flange 156 non-rotatably connected to output hub 160, and spring 158 engaged with plates 154A/154 and flange 156. Hub 160 is arranged to non-rotatably engage an input shaft for a transmission. Lockup clutch 148 is arranged: to be open to enable torque flow from the cover to the output hub via the impeller, the turbine and the damper; and to be closed to enable torque flow from the cover to the output hub via the lockup clutch and the damper.

Advantageously, junction portion 132 has a markedly increased thickness and strength in comparison to known impeller shells, thus providing a desirable increase in the robustness and service life of impeller shell 100 and torque converter 102.

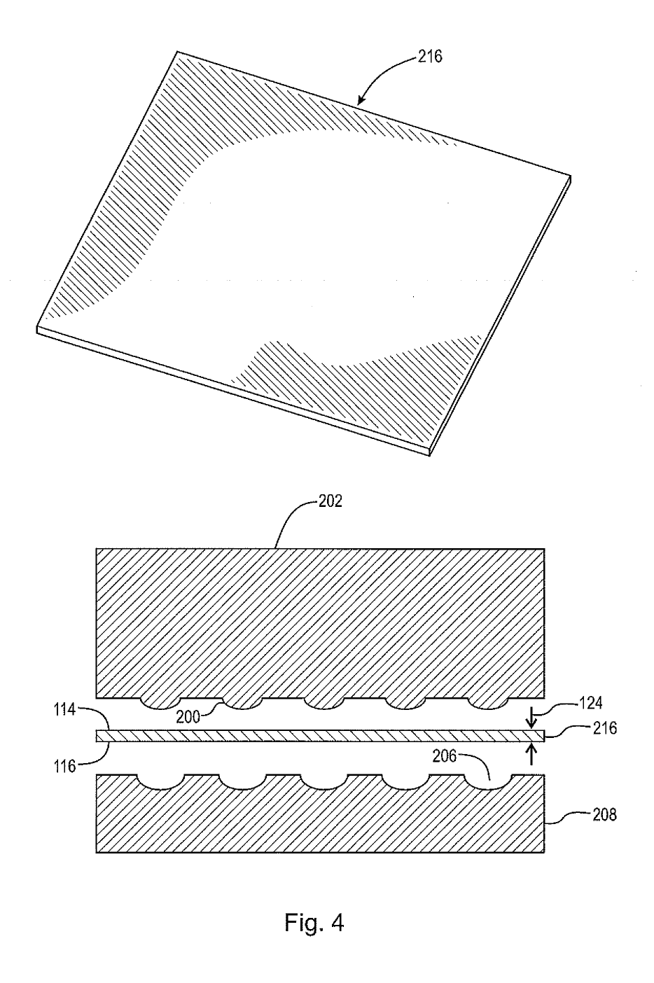

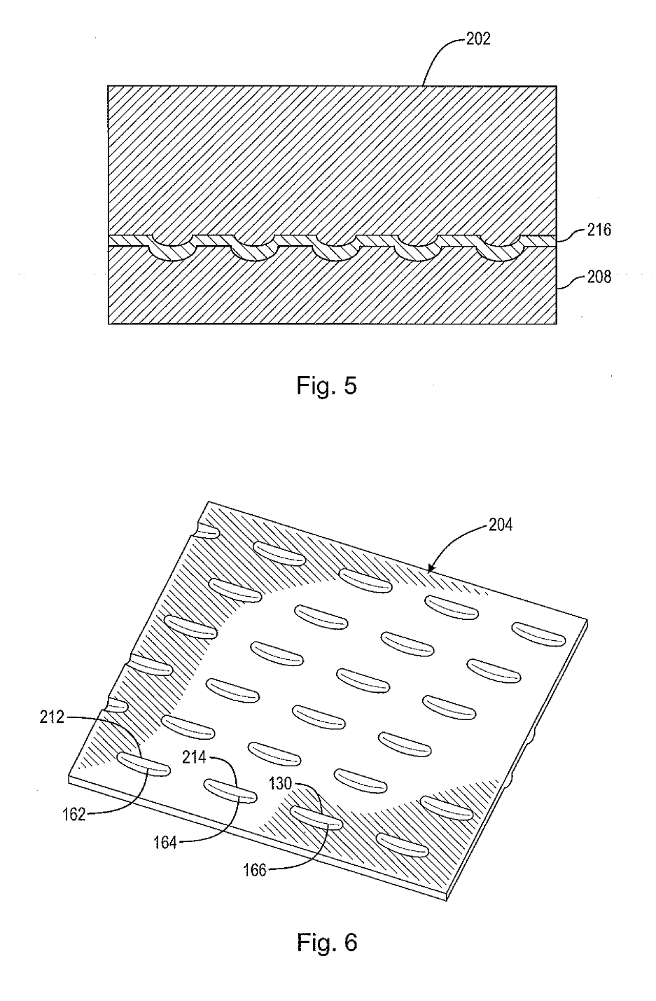

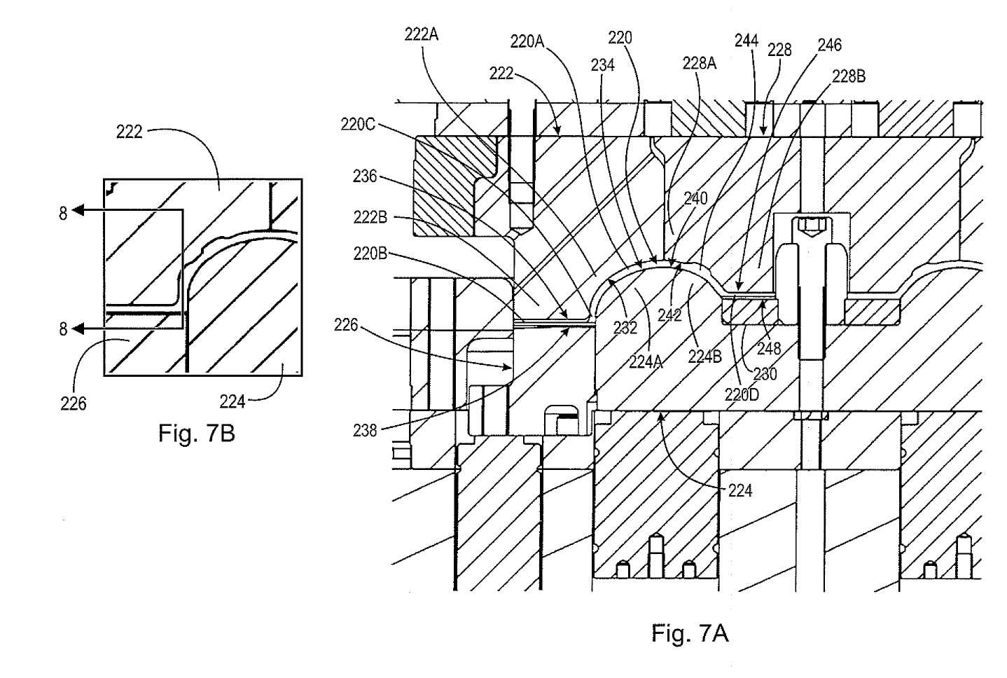

FIGS. 4 through 7B illustrate an example method of fabricating an impeller shell with a thickened junction. Although the method is presented as a sequence of steps for clarity, no order should be inferred from the sequence unless explicitly stated. The following should be viewed in light of FIGS. 2 through 7B. A first step forms, using a plurality of protrusions 200 on die 202 and indentations 206 on die 210, protrusions 212, 214 and 130 on side 116 of sheet 216 of metal having thickness 124. A second step forms slots 162, 164 and 166, in protrusions 212, 214 and 130, respectively. Sheet 216 is placed in space 220 between dies 222, 224, 226, 228, and 230 as described below.

A third step clamps a first portion of sheet 216, corresponding to portion 122 and including slots 162 and protrusions 212, in portion 220A of space 220 between: smooth and continuous curved shape 232 formed by portion 222A of die 222; and smooth and continuous curved shape 234 formed portion 224A of die 224 facing side 116. A fourth step compressing a first end portion of sheet 216 in portion 220B of space 220, between surface 236 formed by portion 222B of die 222 and surface 238 formed by die 226.

A fifth step flows material of sheet 216 in the first portion of sheet 216 toward portion 220C of space 220 corresponding to junction 132. A sixth step blocks the flow of material in portion 220C to the first portion of sheet 216 (space 220A). A seventh step increases the thickness of sheet 216 in portion 220C to thickness 134 greater than thickness 124. An eighth step produces thickness 136.

Clamping the first portion of sheet 216 includes at least partially flattening protrusions 212 to form protrusions 126. In an example embodiment, the first portion of sheet 216 includes protrusions 214 and clamping the first portion of sheet 216 includes at least partially flattening protrusions 214 to form protrusions 128. In an example embodiment, a ninth step clamps a third portion of sheet 214 between: smooth and continuous curved shape 240 formed by portion 224B of die 224; and smooth curved shape 242 formed by portion 228A of die 228 and interrupted by at least one indentation 244 aligned with protrusion 130. Clamping the third portion of sheet 216 includes receiving protrusions 130 in indentation 244 without substantially flattening protrusions 130.

In an example embodiment, a tenth step compresses a fourth portion of sheet 214, corresponding to portion 142, in portion 220D of space 220 between surfaces 246 and 248 formed by portion 228B and die 230, respectively. In an example embodiment, surface 248 is part of die 224.

Advantageously, the method above results in an increase in the thickness and strength of junction 132. In particular, the sixth step noted above blocks the flow of material from junction 132 to portion 122 and the seventh step noted above increases the thickness of shell 100 at junction 132 to thickness 134.

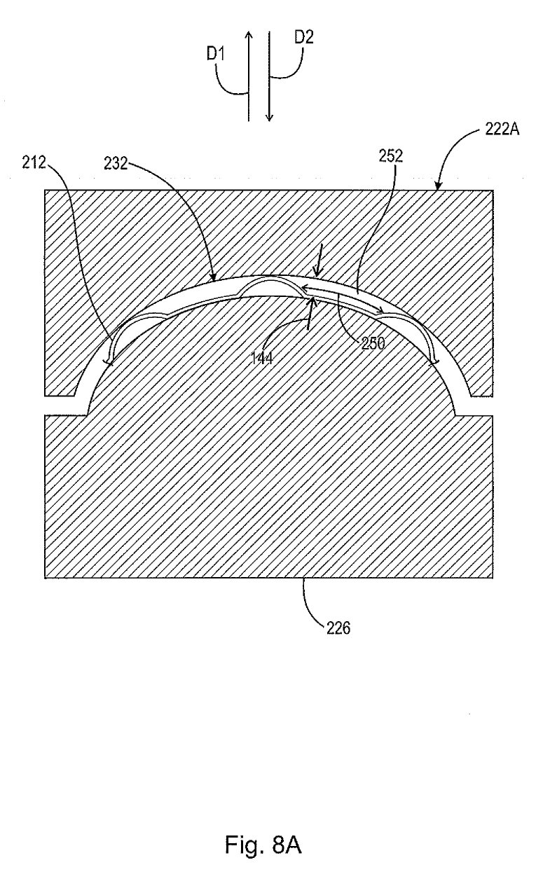

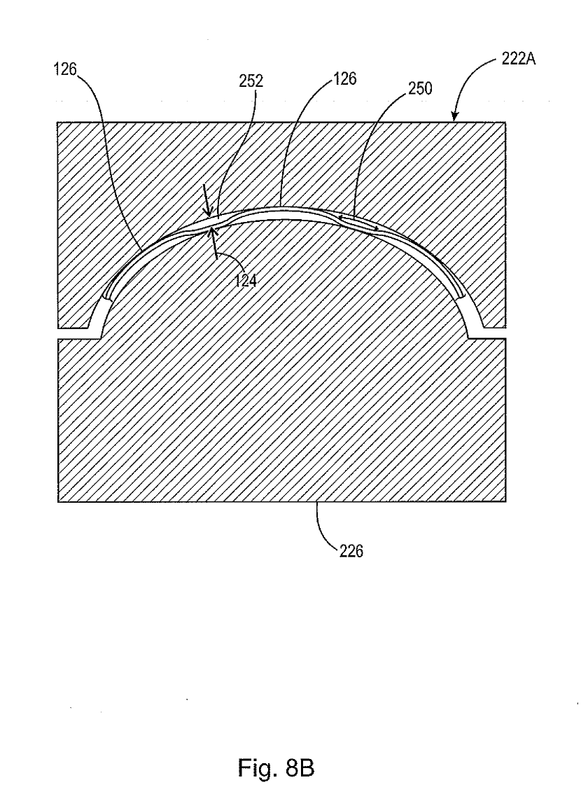

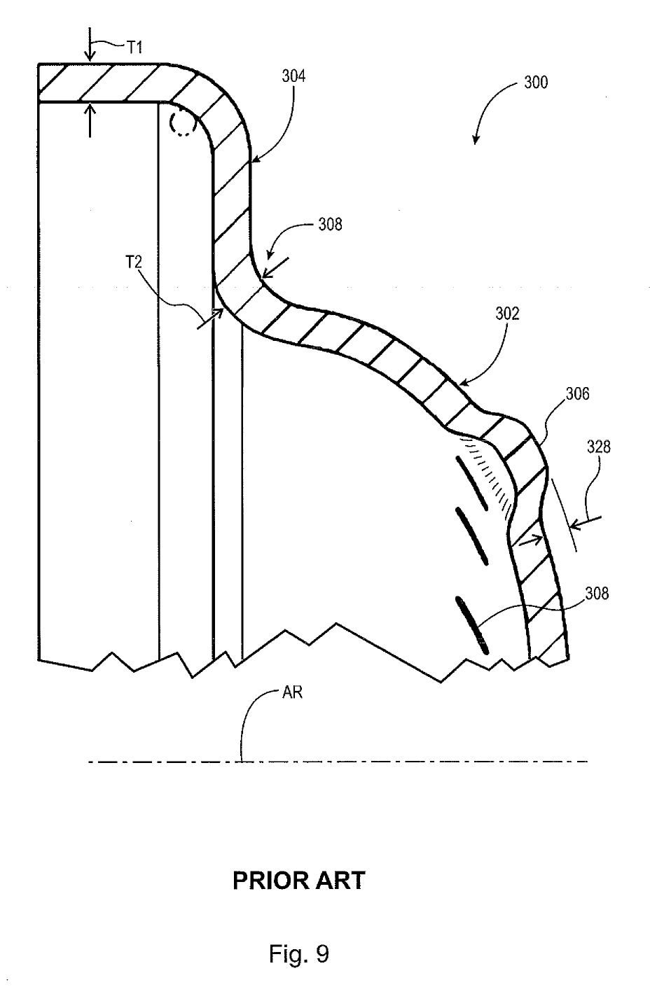

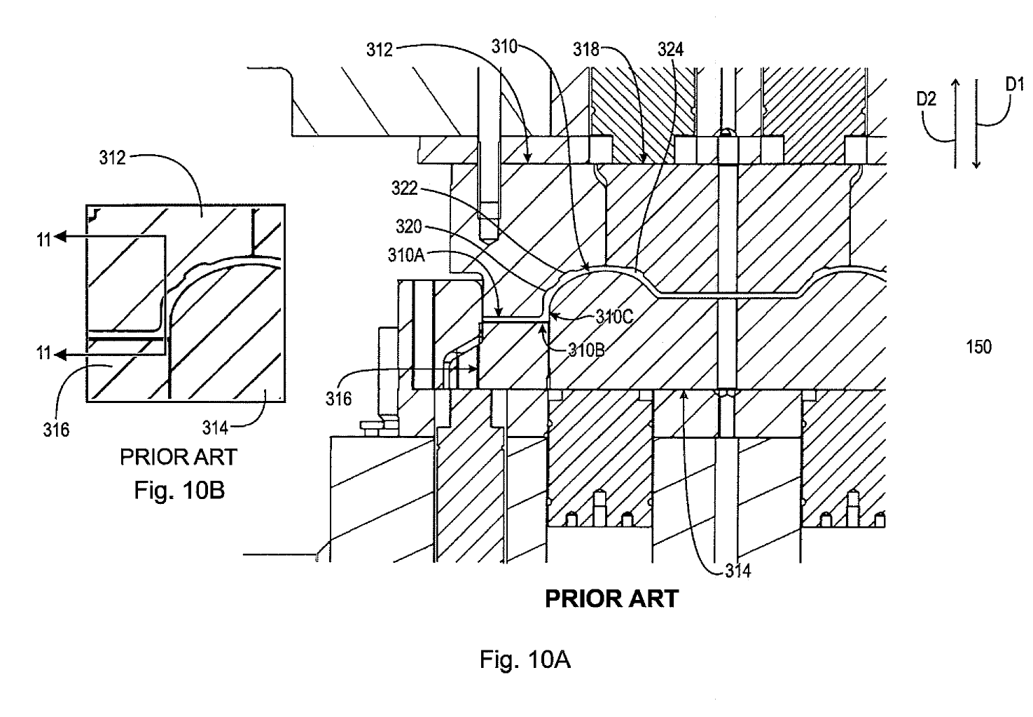

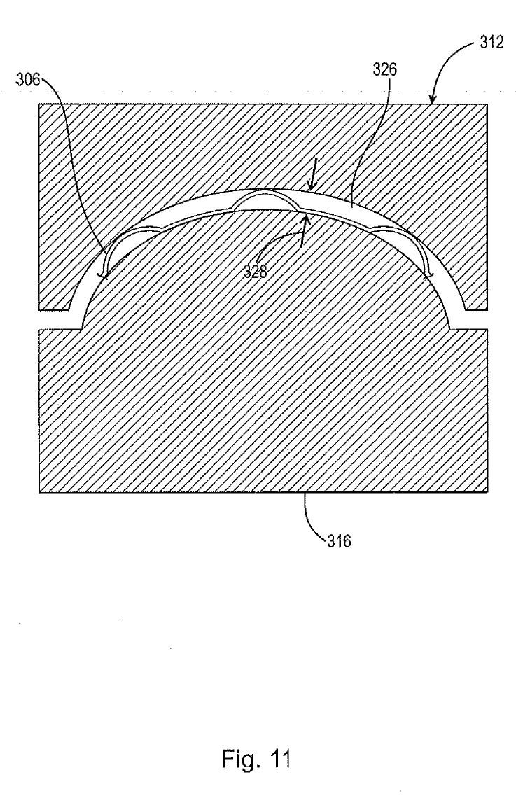

FIG. 8A is a representation of a cross-section along line 8-8 in FIG. 7 showing protrusions 212 before compression between dies 222 and 224.

FIG. 8B is a representation of a cross-section along line 8-8 in FIG. 7 showing protrusions 126 formed by compressing protrusions 212. The following should be viewed in light of FIGS. 2 through 8B. The dashed lines in FIGS. 8A and 8B represent sheet 216. The blocking function of the sixth step is enabled by smooth continuous shape 232 formed portion 222A of die 222. As noted above, die 222 must be configured to enable displacement of die 222 in direction D1 and D2 without snagging protrusions 212. Unlike in the prior art, shape 232 is not configured to receive protrusion 212 while applying only nominal pressure. Instead, the shallow profile of shape 232 causes considerable pressure to be imposed on protrusions 212.

For example, in FIG. 8A, contact has been made between sheet 216 and die 222, but compressive force has not been applied to protrusions 212. Adjacent protrusions 212 are separated by distance 250 in space 252. In an example embodiment, 212 extends by distance 144 from portion 122. As shown in FIG. 8B, distance 250 and space 252 are dramatically reduced after compression between dies 222 and 224. The reduction of space 252 reduces the area through which material can flow from portion 132 to 122A, which results in the thickening of portion 132 noted above. That is, sheet 216 is compressed in areas under protrusion 126, resulting in the halting or impeding of material flow from junction 132 to portion 122.

It should be understood that the dies shown in FIGS. 7A and 7B can be differently configured while still providing the surfaces and shapes described above. For example: dies 222 and 228 could be combined into a single die; and dies 224 and 226 could be combined into a single die.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A torque converter, comprising:
a cover arranged to receive torque;
a turbine including:
a turbine shell; and,
a turbine blade fixedly connected to the turbine shell;
an impeller including an impeller shell, the impeller shell non-rotatably connected to the cover and including:
an inner surface facing the turbine;
an outer surface facing opposite the inner surface;
a first radial portion substantially orthogonal to an axis of rotation for the torque converter;
an axial portion:
substantially parallel to the axis of rotation;
extending from the radial portion;
forming a radially outmost portion of the impeller shell; and,
having a first thickness;
a curved portion radially inward of the first radial portion and including:
a first protrusion;
second and third protrusions radially inward of the first protrusion; and,
a first portion between the first and second protrusions;
a junction portion connecting the radial portion and the curved portion and having a second thickness at least 50 percent greater than the first thickness; and,
an impeller blade fixed to the impeller shell proximate the first, second and third protrusions.

2. The torque converter of claim 1, wherein the first radial portion has a third thickness less than the first thickness.

3. The torque converter of claim 2, wherein the first, second and third thicknesses are measured orthogonal to the inner or outer surface.

4. The torque converter of claim 1, wherein the impeller shell includes:
a second radial portion:
radially inward of the first, second, and third protrusions;
substantially orthogonal to the axis of rotation;
forming a radially inmost portion of the impeller shell; and,
having the first thickness;
the third protrusion is radially inward of the second protrusion; and,
the curved portion includes a second portion:
between the second and third protrusions; and,
having the first thickness.

5. The torque converter of claim 1, wherein the first portion has the first thickness.

6. The torque converter of claim 1, wherein:
the first protrusion extends past the first portion, in a direction orthogonal to the outer surface, by a first amount;
the third protrusion is radially inward of the second protrusion;
the curved portion includes a second portion between the second and third protrusions; and,
the third protrusion extends past the second portion, in the direction, by a second amount more than twice the first amount.

7. The torque converter of claim 1, further comprising:
a lock up clutch; and,
a damper including an input part, an output part and a spring engaged with the input and output parts, wherein:
the lockup clutch is arranged to be open to enable torque flow from the cover to the output hub via the impeller, the turbine and the damper; and,
the lockup clutch is arranged to be closed to enable torque flow from the cover to the output hub via the lockup clutch and the damper.

8. A method of fabricating an impeller for a torque converter, comprising:
forming, using a first plurality of protrusions on a first die and a plurality of indentations in a second die, first, second, and third protrusions extending from a first side of a sheet of metal, the sheet of metal having a first thickness;
forming, using the first plurality of protrusions and the plurality of indentations, first, second, and third slots in the first, second, and third protrusions, respectively;
clamping a first portion of the sheet metal, including the first protrusion and the first slot, between:
a first smooth and continuous curved shape formed by a first portion of a third die facing the first side; and,
a second smooth and continuous curved shape formed by a first portion of a fourth die;
compressing a first end portion of the sheet of metal, continuous with the first portion of the sheet metal, between a first surface formed by a second portion of the third die and a second surface formed by a fifth die;
flowing material forming the first end portion into a junction between the first portion and the first end portion;
blocking the flow of material from the junction to the first portion; and,
increasing the thickness of the sheet of metal at the junction to a second thickness greater than the first thickness by at least 50 percent.

9. The method of claim 8, further comprising:
reducing a third thickness of at least a portion of the first end portion to be less than the first thickness.

10. The method of claim 8, wherein clamping the first portion of the sheet metal includes at least partially flattening the first protrusion.

11. The method of claim 10, wherein:
the first portion includes the second protrusion and the second slot; and,
clamping the first portion of the sheet metal includes at least partially flattening the second protrusion.

12. The method of claim 8, further comprising:
clamping a second portion of the sheet of metal between:
a third smooth and continuous curved shape formed by a second portion of the fourth die; and,
a fourth curved shape formed by a first portion of a sixth die and interrupted by a first indentation aligned with the third protrusion.

13. The method of claim 12, wherein clamping the second portion of the sheet of metal includes receiving the third protrusion in the first indentation without substantially flattening the third protrusion.

14. The method of claim 12, further comprising:
compressing a second end portion of the sheet of metal, opposite the first end portion of the sheet of metal and continuous with the second portion of the sheet metal, between third and fourth surfaces formed by a second portion of the sixth die and a seventh die, respectively.

15. A method of fabricating an impeller for a torque converter, comprising:
forming, using a first plurality of protrusions on a first die and a plurality of indentations in a second die, first, second, and third protrusions extending from a first side of a sheet of metal, the sheet of metal having a first thickness;
forming, using the first plurality of protrusions and the plurality of indentations, first, second, and third slots in the first, second, and third protrusions, respectively;
clamping a first portion of the sheet metal, including the first protrusion and the first slot, between:
a first smooth and continuous curved shape formed by a first portion of a third die facing the first side; and,
a second smooth and continuous curved shape formed by a first portion of a fourth die;
at least partially flattening the first protrusion with the first portion of the third die;
compressing a first end portion of the sheet of metal, continuous with the first portion of the sheet metal, between a first surface formed by a second portion of the third die and a second surface formed by a fifth die;
flowing material forming the first end portion into a junction between the first portion and the first end portion;
blocking the flow of material from the junction to the first portion; and,
increasing the thickness of the sheet of metal at the junction to a second thickness greater than the first thickness by at least 50 percent.

16. The method of claim 15, further comprising:
reducing a third thickness of at least a portion of the first end portion to be less than the first thickness.

17. The method of claim 15, wherein:
the first portion includes the second protrusion and the second slot; and,
clamping the first portion of the sheet metal includes at least partially flattening the second protrusion.

18. The method of claim 15, further comprising:
clamping a second portion of the sheet of metal between:
a third smooth and continuous curved shape formed by a second portion of the fourth die; and,
a smooth curved shape formed by a first portion of a sixth die and interrupted by a first indentation aligned with the third protrusion.

19. The method of claim 18, wherein clamping the second portion of the sheet of metal includes receiving the third protrusion in the first indentation without substantially flattening the third protrusion.

20. The method of claim 15, further comprising:
compressing a second end portion of the sheet of metal, opposite the first end portion of the sheet of metal and continuous with the second portion of the sheet metal, between third and fourth surfaces formed by the second portion of the sixth die and a seventh die, respectively.
